(19) United States
(12) Patent Application Publication
(10) Pub. No.: US 2026/0309039 A1
(43) Pub. Date: Oct. 8, 2026

(54) ASSEMBLY FOR MAINTAINING AND RETAINING A GAS TURBINE ENGINE COMPONENT

(71) Applicant: RTX CORPORATION, Farmington, CT (US)

(72) Inventors: Andrew HAINES, West Palm Beach, FL (US); Joseph WILSON, Jupiter, FL (US); Samuel Enrique VARGAS VEGA, Palm City, FL (US); Howard J. LILES, Newington, CT (US); James T. ROACH, Vernon, CT (US); Christian X. CAMPBELL, West Hartford, CT (US); Robert A. WHITE, III, Meriden, CT (US); Thiago B. VIEIRA, Sarasota, FL (US); David Dwyer WHITTLE, Suffield, CT (US); David J. WASSERMAN, Hamden, CT (US)

(73) Assignee: RTX CORPORATION, Farmington, CT (US)

(21) Appl. No.: 19/170,037

(22) Filed: Apr. 3, 2025

(51) Int. Cl. F01D 9/04

(52) U.S. Cl. CPC F01D 9/042; F05D 2260/30

(57) ABSTRACT

A gas turbine engine comprising a ring having an inner ring and an outer ring that define a gas path therebetween, at least one of the inner ring and the outer ring include two or more rings; a vane disposed in the gas path and supported by the inner ring and the outer ring, the vane includes an inner platform and an outer platform, wherein at least one of the inner rings and outer rings include one or more flange designed to abut an opposing flange defined by at least one of the inner platform and the outer platform, a contact surface designed to abut an opposing contact surface defined by at least one of the inner platform and the outer platform, and an angled contact surface designed to abut an opposing angled contact surface defined by at least one of the inner platform and the outer platform.

### CROSS REFERENCE TO RELATED APPLICATIONS

The present application is related to co-pending U.S. patent application Ser. No. ______(RTX Ref. No. 184273US 01/MWZB Ref. No. RTXPW-0122), filed Apr. 3, 2025, as the present application and assigned to the same assignee of record.

### FIELD OF THE INVENTION

The subject matter disclosed herein relates to a gas turbine engine component and, in particular, to an assembly for maintaining and retaining the gas turbine engine component.

### BACKGROUND OF THE INVENTION

Referring to FIG. 1, previous work identified a new way of constraining ceramic matrix composite-containing vanes 10 between two monolithic and continuous ceramic rings 20, 30 for the purpose of mounting and retaining the vanes. Further study and development has revealed that under certain circumstances, single monolithic rings at the inner diameter 20 and outer diameter 30 are not sufficient. Certain use cases for ceramic matrix composites, for instance the ring-strut-ring configuration illustrated in FIG. 1, push the limitations of ceramic matrix composite. Moreover, this configuration is further challenged by the added presence of axial, circumferential, and/or pressure loads on the component(s) that also contribute to stress(es).

Referring now to FIG. 2, ceramic matrix composites 40 exhibit and possess lower strength than typical metals used for fabricating gas turbine engine components, e.g., inner and outer rings, and vanes. Inner and outer rings require simultaneously carrying both high hoop and high axial compressive load necessitates a thick cross-section to reduce mechanical stress. However, ceramic matrix composite containing-components possess a manufacturing limitation. A larger cross-section area may not be possible due to densification limitations. The chemical vapor infiltration (CVI) process deposits material on the outer piles of a ceramic matrix composite wall. The interior may be left with relatively low matrix density if the ceramic matrix composite wall is too thick. If the thickness 50 is too large, the interior region 60 of the ceramic matrix composite containing-component may not fully densify like densified region 70, thus resulting in unacceptably poor material properties. For example, a ceramic matrix composite having a low matrix density has reduced strength allowables because the composite is prone to oxidation embrittlement. As a result, a thick ceramic matrix composite-containing ring does not have the structural properties needed to carry the radial hoop plus axial compression combined stress state. Furthermore, ceramic matrix composite-containing components are also subjected to high thermal gradients, e.g., hot-to-cold, over a very short distance that results in large thermal ‘fights’ which cause internal stress(es).

Referring now to FIG. 3, the radial force 80 applied to a ring, e.g., an outer ring 30, results in hoop stress (as illustrated by arrows 90). The cross-sectional area 100 of the ring 30 determines the stress for a given load; a larger cross-sectional area provides a lower stress load. The ceramic matrix composite containing-component's strength and thickness are both impactful to the component's ability to withstand hoop stress, thus making the component particularly challenged. At the same time, these limitations may be further exacerbated in configurations involving conical rings where hoop stress tends to concentrate at the wider end. In such configurations, the outer ring 30 is subject to high radial load from the ceramic matrix composite containing-component, e.g., vane, resulting the aforementioned hoop stress.

Referring now to FIG. 4, the outer ring 30 is also subject to a very large thermal gradient as the ring 30 is in thermal contact with the very hot ceramic matrix composite containing-component and the relatively much colder gas turbine engine case. The thermal load add to the mechanical load state of the ring 30. As heat transfer (as illustrated by arrow 110a) to a heat sink (as illustrated by arrow 110b) occurs, the high temperature area 120 tries to pull (in the direction of arrows 130) the low temperature area 140 along with the high temperature as the low temperature also grows (in the direction of arrows 150), resulting in hoop stress 90 in the low temperature area 140.

Consequently, there exists a need for a configuration that distributes the axial, circumferential, and/or pressure loads to compensate for the configuration(s) of the prior art as well as the limitations of ceramic matrix composite-containing components.

### SUMMARY OF THE INVENTION

The present disclosure is directed, in a first aspect, to a gas turbine engine, comprising: a turbine section disposed about an engine axis, the turbine section including a ring comprising an inner ring and an outer ring that define a gas path therebetween, at least one of the inner ring and the outer ring include two or more rings; at least one vane disposed in the gas path and supported by the inner ring and the outer ring, the vane includes an inner platform, an outer platform, and an airfoil section disposed therebetween, wherein at least one of the two or more inner rings and two or more outer rings include one or more of: (i) at least one aft end or fore end designed to abut an opposing flange defined by at least one of the inner platform and the outer platform, (ii) at least one contact surface designed to abut an opposing contact surface defined by at least one of the inner platform and the outer platform, and (iii) at least one angled contact surface designed to abut an opposing angled contact surface defined by at least one of the inner platform and the outer platform.

In further embodiments of the present disclosure, including further embodiments of the above exemplary embodiments, the at least one contact surface protrudes radially-outwardly.

In further embodiments of the present disclosure, including further embodiments of the above exemplary embodiments, the inner ring includes one ring and the outer ring includes two or more rings.

In further embodiments of the present disclosure, including further embodiments of the above exemplary embodiments, the inner ring includes two or more rings and the outer ring includes one ring.

In further embodiments of the present disclosure, including further embodiments of the above exemplary embodiments, the inner ring includes two or more rings and the outer ring includes two or more rings.

In further embodiments of the present disclosure, including further embodiments of the above exemplary embodiments, the outer ring includes two or more rings and a first outer ring includes a first contact surface, a second outer ring includes a second opposing contact surface, and the first contact surface and the second opposing contact surface are designed to abut each other.

In further embodiments of the present disclosure, including further embodiments of the above exemplary embodiments, the two or more outer rings define at least one insulating air gap.

In further embodiments of the present disclosure, including further embodiments of the above exemplary embodiments, the two or more inner rings define at least one insulating air gap.

In further embodiments of the present disclosure, including further embodiments of the above exemplary embodiments, at least one of the two or more outer rings include one or more cooling apertures.

In further embodiments of the present disclosure, including further embodiments of the above exemplary embodiments, further comprising at least one insulating air gap defined by one or more of the following: the inner ring, the outer ring and the vane.

In further embodiments of the present disclosure, including further embodiments of the above exemplary embodiments, further comprising a compressor section, a combustor in fluid communication with the compressor section and the turbine section.

In further embodiments of the present disclosure, including further embodiments of the above exemplary embodiments, at least one of the inner ring, the outer ring and the vane comprises a ceramic-containing material.

In further embodiments of the present disclosure, including further embodiments of the above exemplary embodiments, the ceramic-containing material comprises at least one of the following: a silicon-containing ceramic, a ceramic-matrix composite, and combinations thereof.

In another embodiment, the present disclosure is directed to a gas turbine engine, comprising: a turbine section disposed about an engine axis, the turbine section including a ring comprising an inner ring and an outer ring that define a gas path therebetween, at least one of the inner ring and the outer ring include a split ring; at least one vane disposed in the gas path and supported by the inner ring and the outer ring, the vane includes an inner platform, an outer platform, and an airfoil section disposed therebetween, wherein the split ring includes one or more of: (i) at least one aft end or fore end designed to abut an opposing flange defined by at least one of the inner platform and the outer platform, (ii) at least one contact surface designed to abut an opposing contact surface defined by at least one of the inner platform and the outer platform, and (iii) at least one angled contact surface designed to abut an opposing angled contact surface defined by at least one of the inner platform and the outer platform.

In further embodiments of the present disclosure, including further embodiments of the above exemplary embodiments, the split ring includes a body having an aft end and a fore end and a fork having an upper fork portion and a lower fork portion, the upper and lower fork portions extending axially-outwardly, the fork being disposed opposite either the aft end or the fore end of the body.

In further embodiments of the present disclosure, including further embodiments of the above exemplary embodiments, at least one of the inner ring, the outer ring and the vane comprises a ceramic-containing material.

In further embodiments of the present disclosure, including further embodiments of the above exemplary embodiments, the ceramic-containing material comprises at least one of the following: a silicon-containing ceramic, a ceramic-matrix composite, and combinations thereof.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1, not drawn to scale, is a frontal and cross-sectional view of a ring-strut-ring configuration of the prior art found within a gas turbine engine, not drawn to scale.

FIG. 2, not drawn to scale, is a ceramic matrix composite exhibiting an interior region that is less densified than a densified region whose thickness is too large.

FIG. 3, not drawn to scale, is a cross-sectional view of the radial forces and hoop stress applied during operation to the outer ring of the prior art of FIG. 1.

FIG. 4, not drawn to scale, is a cross-sectional view of the thermal load and hoop stress experienced by the outer ring of the prior art of FIGS. 1 and 3.

FIG. 5, not drawn to scale, illustrates a schematic, cross-sectional view of a gas turbine engine.

FIG. 6, not drawn to scale, illustrates an embodiment utilizing a single inner ring and a single outer ring.

FIG. 7, not drawn to scale, illustrates an embodiment utilizing a single inner ring and two exemplary outer rings.

FIG. 8A, not drawn to scale, illustrates the force(s) and load(s) acting on the two exemplary outer rings of FIG. 7.

FIG. 8B, not drawn to scale, illustrates the force(s) and load(s) acting on two other exemplary outer rings based on the two exemplary outer rings of FIG. 7.

FIG. 8C, not drawn to scale, illustrates the thermal load(s) experienced by the two exemplary outer rings of FIG. 7.

FIG. 9, not drawn to scale, illustrates another embodiment utilizing a single inner ring and yet two other exemplary outer rings based on the two outer rings of FIG. 7.

FIG. 10, not drawn to scale, illustrates an embodiment utilizing two exemplary inner rings and a single outer ring.

FIG. 11, not drawn to scale, illustrates an embodiment utilizing the two exemplary inner rings of FIG. 10 and the two exemplary outer rings of FIG. 9.

FIG. 12, not drawn to scale, illustrates an embodiment utilizing a single inner ring and four exemplary outer rings.

FIG. 13, not drawn to scale, illustrates an embodiment utilizing a single inner ring and two exemplary outer rings.

FIG. 14A, not drawn to scale, illustrates an embodiment utilizing an exemplary split ring as an outer ring.

FIG. 14B, not drawn to scale, illustrates the thermal load experienced by the exemplary split ring of FIG. 14A.

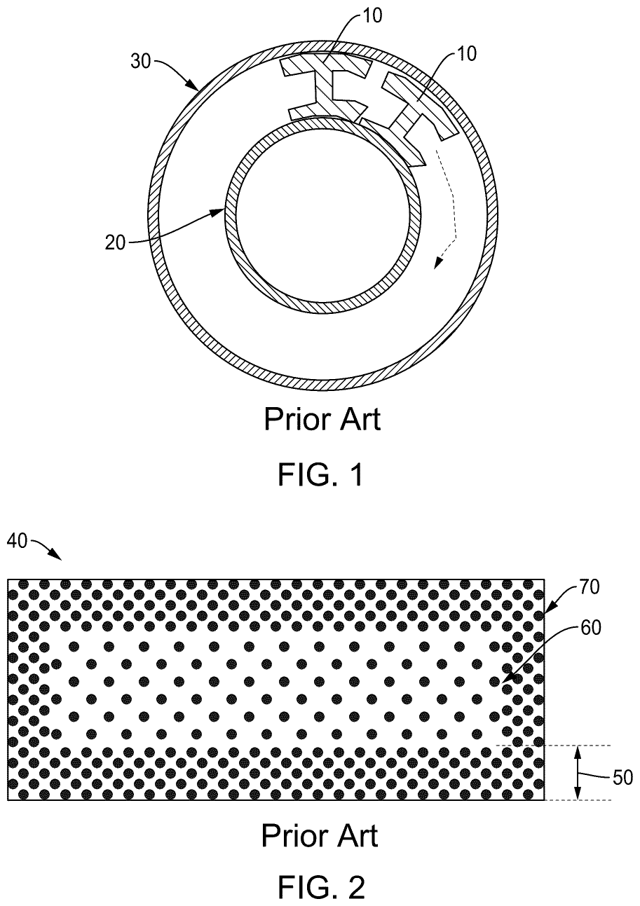

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces in the direction toward the flow of the hot gases, i.e., faces upstream. The trailing edge/portion of a structure is the edge/portion that the faces in the direction away from the flow of the hot gases, i.e., faces downstream. Ceramic-containing material refers to materials containing at least one ceramic, such as, but not limited to, silicon-containing ceramic materials, composite materials (e.g., ceramic matrix composite); individually, and combinations thereof; and the like.

The present disclosure is directed to a ring-strut-ring configuration encompassing various embodiments incorporating one or more inner rings or one or more outer rings or both. By utilizing a plurality of rings in any one of the various embodiments, the aforementioned loads originating from a vane may be disseminated to the surrounding structure(s) in more direct ways, thus limiting the stress(es) experienced by each individual ring. The exemplary structural configuration overcomes the manufacturing and structural limitations mentioned above with respect to ceramic-containing materials.

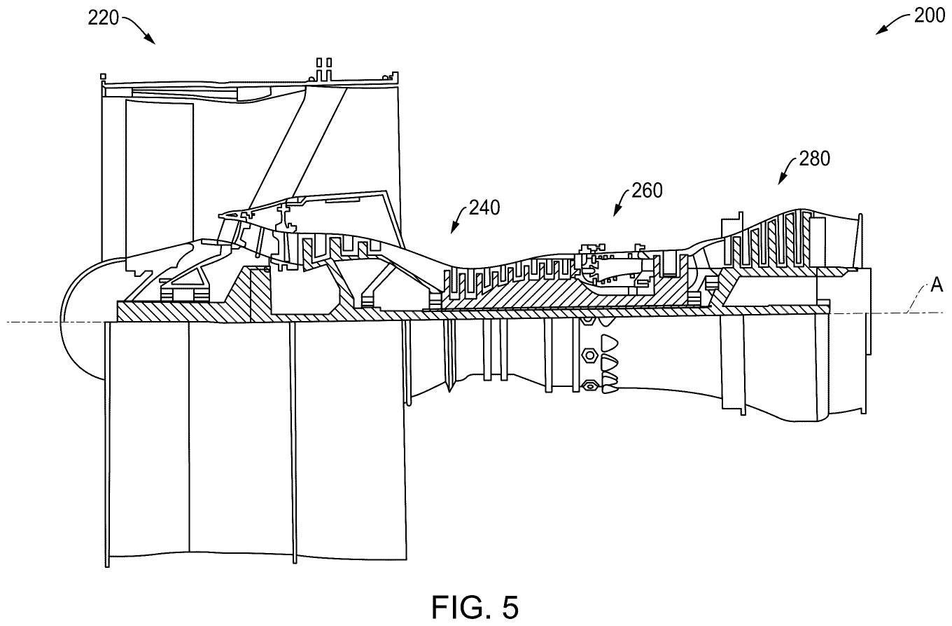

Referring now to FIG. 5, a gas turbine engine 200 is schematically illustrated. The exemplary gas turbine engine 200 is a two-spool turbofan engine that generally incorporates a fan section 220, a compressor section 240, a combustor section 260 and a turbine section 280 about an engine centerline longitudinal axis A. Alternative engines might include an augmenter section (not shown) among other systems for features. The fan section 220 drives air along a bypass flow path in a bypass duct defined within a fan case, while the compressor section 240 drives air along a core flow path for compression and communication into the combustor section 260 then expansion through the turbine section 280. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

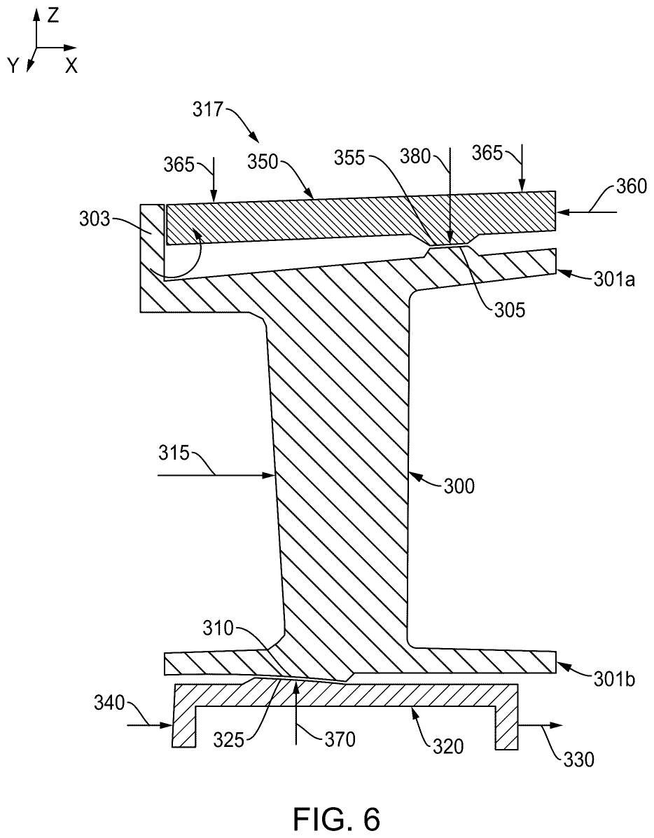

Referring now to FIG. 6, during operation of at least one embodiment, at least one vane 300, e.g., a row of vanes 300, may include an outer platform 301a having an outer platform flange 303 and an opposing contact surface 305, and an inner platform 301b having an opposing angled contact surface portion 310 extending radially-inwardly. During operation, the vane 300 may experience an aerodynamic load in the direction of arrow 315. The outer platform flange 303 and opposing contact surface 305 may each extend radially-outwardly. In at least one embodiment, a ring 317 may comprise an inner ring 320 and an outer ring 350, and may be concentrically disposed about the vane 300 or row of vanes 300. The inner ring 320, having an angled contact surface 325 extending radially-outwardly, may move axially downstream in the direction of arrow 330 due to pressure applied in the direction of arrow 340. And, the outer ring 350 abutting the outer platform flange 303, and having a contact surface 355 extending radially-inwardly, may experience an axial compressive load in the direction of arrow 360 and radial compressive load in the direction of arrows 365. The combined pressures applied in the directions of arrows 340, 360, 365 may create a compression load in the directions of arrow 370 and arrow 380. That compressive load experienced by the vane 300 may be lessened due to the angled contact surface 325 of inner ring 320 in contact with the opposing angled contact surface portion 310 of the vane 300, and the contact surface 355 of outer ring 350 in contact with the opposing contact surface 305 of the vane 300. And, hoop stress still may be generated within the outer ring 350. However, when outer ring 350 is substituted with, e.g., more than one outer ring, the multiple outer rings may contact each other in one or more locations, either continuously or under certain gas turbine engine conditions, so as to permit dividing and transferring the compression load and hoop stress amongst the multiple rings. The motion(s) induced by the aforementioned pressure loads may be stopped by contact made by the angled contact surface portion 325 and the opposing angled contact surface portion 310, and contact surface 355 and opposing contact surface 305. The opposing points of contact, that is, opposing contact surface 305 and opposing angled contact surface 310, and the pressure loads experienced at each, may generally be referred to as the cross-corner load experienced by the vane(s) 300.

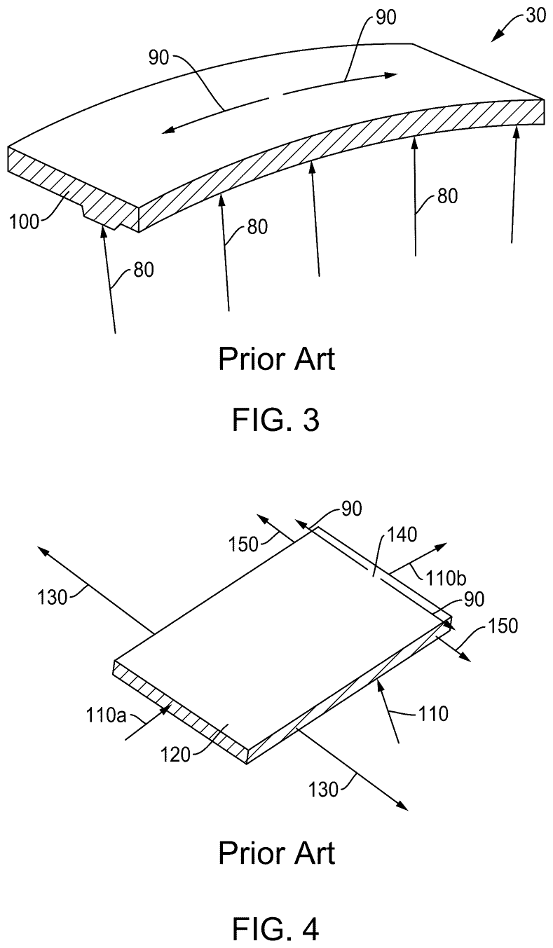

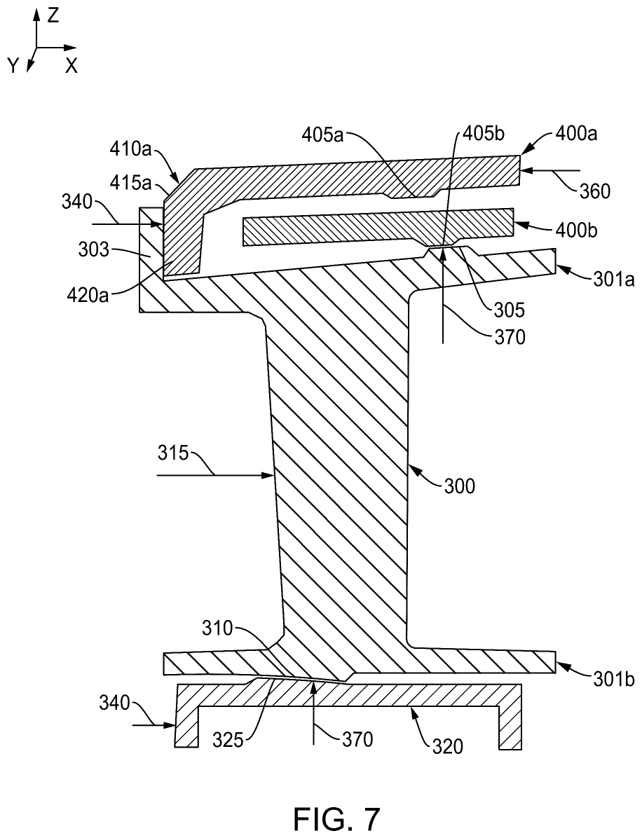

Referring now to FIG. 7, in at least one embodiment, two or more outer rings 400a, 400b may replace the single outer ring 350. The outer ring 400a may be disposed in contact with the outer platform flange 303 via an outer ring flange 410a extending radially-inwardly, while the outer ring 400b may be disposed in contact with the opposing contact surface 305 via a contact surface 405b. The outer ring flange 410a may include an arm 415a and a trunk 420a. In at least one embodiment, the outer platform flange 303 and outer ring flange 410a may or may not abut, when the gas turbine engine 200 is either resting or operating. In at least one other embodiment, the contact surface 405a may or may not abut the ring 400b when the gas turbine engine 200 is either resting or operating. In yet at least one other embodiment, the contact surface 405b may or may not abut the opposing contact surface 305 when the gas turbine engine 200 is either resting or operating. During operation, the outer ring flange 410a may serve as a retainer and engage the outer platform flange 303. That is, the outer ring flange 410a may limit axially aftward movement (as indicated by arrow 330 of FIG. 6) of the vane 300. The outer platform flange 303 and outer ring flange 410a may enable the mechanical support of vane 300 without the need for internal spars to support the load. The motion(s) induced by the aforementioned pressure loads may be stopped by contact made by the angled contact surface portion 325 and the opposing angled contact surface portion 310, and contact surface 405b and opposing contact surface 305. The opposing points of contact, that is, opposing contact surface 305 and opposing angled contact surface 310, and the pressure loads experienced at each, may be the cross-corner load experienced by the vane(s) 300. In addition, as discussed above, a larger cross-sectional area provides a lower stress load (see FIG. 3). Depending on the anticipated load(s), the outer ring 400a and contact surface 405a, as well as the outer ring 400b and contact surface 405b, may be fabricated having respective cross-sectional areas suitable to react, reduce and distribute the stress load(s) being experienced. In addition, the air gaps between the outer rings 400a, 400b may insulate and facilitate transferring heat from a heat source, e.g., vane 300, to a heat sink.

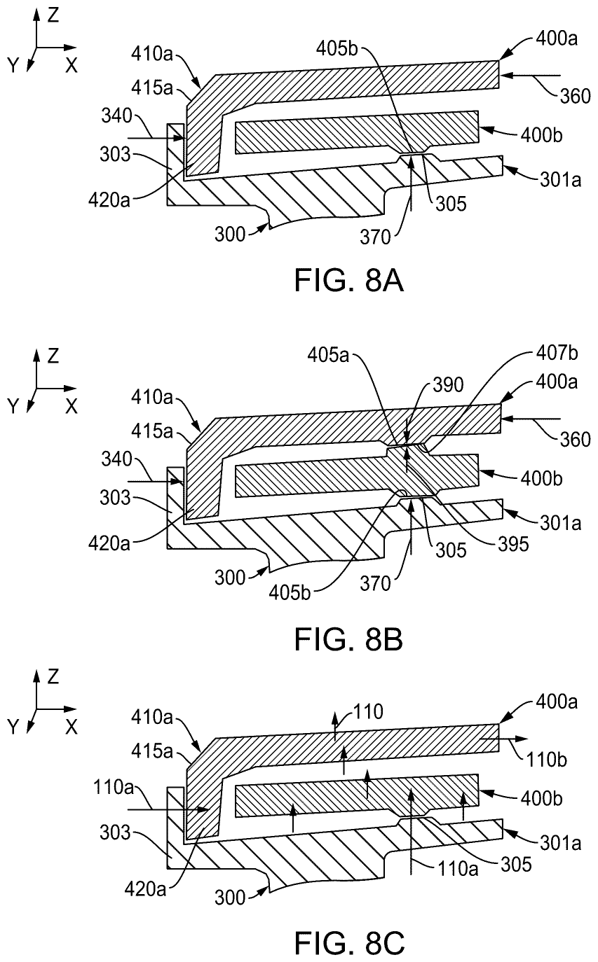

Referring now to FIGS. 8A-8C, the stress and thermal loads experienced by two or more rings, e.g., outer rings 400a, 400b, may be considered further. Given the aforementioned structural configuration, the outer rings 400a, 400b may also serve to react out various aerodynamic loads from the vane 300 to an outer turbine case (not shown) as illustrated by arrows 340, 360, 370 (see FIG. 8A). In yet another embodiment, outer ring 400b may include an additional contact surface 407b that may engage contact surface 405a (see FIG. 8B). In such a structural configuration, the outer rings 400a, 400b may share the load at the interface of surfaces 405a and 407b and limit the hoop stress, induced by loads applied in the directions of arrows 390 and 395, experienced by either or both rings 400a, 400b. In addition, by being separated, the outer rings 400a, 400b may not share thermal load (as indicated by arrows 110) through contact (see FIG. 8C). For example, in FIG. 8B, the thermal load from the vane 300 may be absorbed in bulk by the outer ring 400b and then lessened further, through dissipation, when passing through the insulating air gaps before contacting the outer ring 400a.

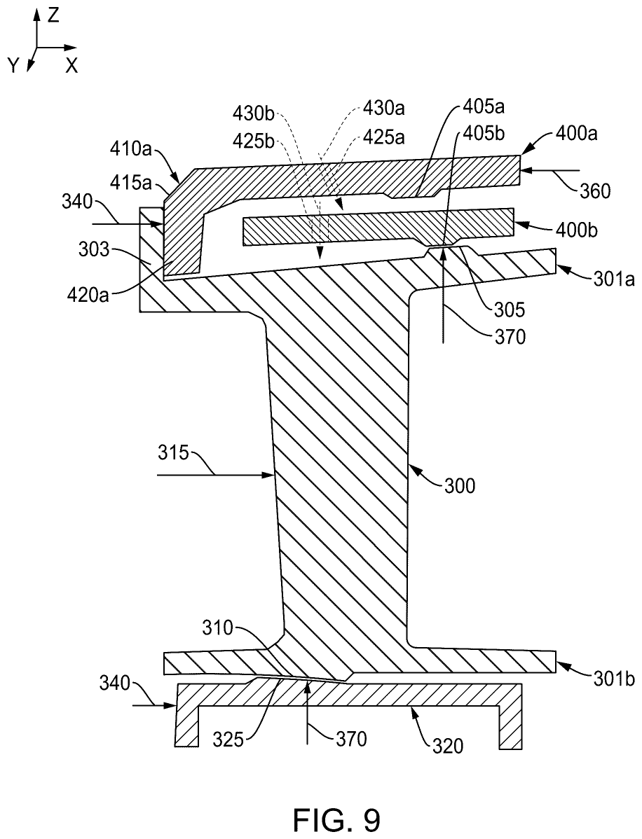

Referring to FIG. 9, in an alternative embodiment of the structural configuration illustrated in FIG. 7, each outer ring 400a, 400b may include at least one cooling aperture 425a, 425b, respectively. Bypass air flow (as indicated by arrows 430a, 430b) may be drawn from the bypass duct through the including cooling apertures 425a, 425b of the outer rings 400a, 400b to the vane 300. The bypass air flow may help diminish the thermal load experienced by the outer rings 400a, 400b and vane 300. In at least one embodiment, the cooling apertures 425a, 425b may be fabricated in a non-high stress area of the outer rings 400a, 400b. Any technique capable of forming the cooling apertures without impacting the structural integrity of the rings 400a, 400b may be suitable for use herein. Suitable techniques may include, but are not limited to, mechanical drill, laser; individually, and combinations thereof; and the like. The cooling apertures 425a, 425b may work in conjunction with the insulating air gaps between the outer rings 400a, 400b and vane 300 to facilitate transferring heat from the heat source to the heat sink.

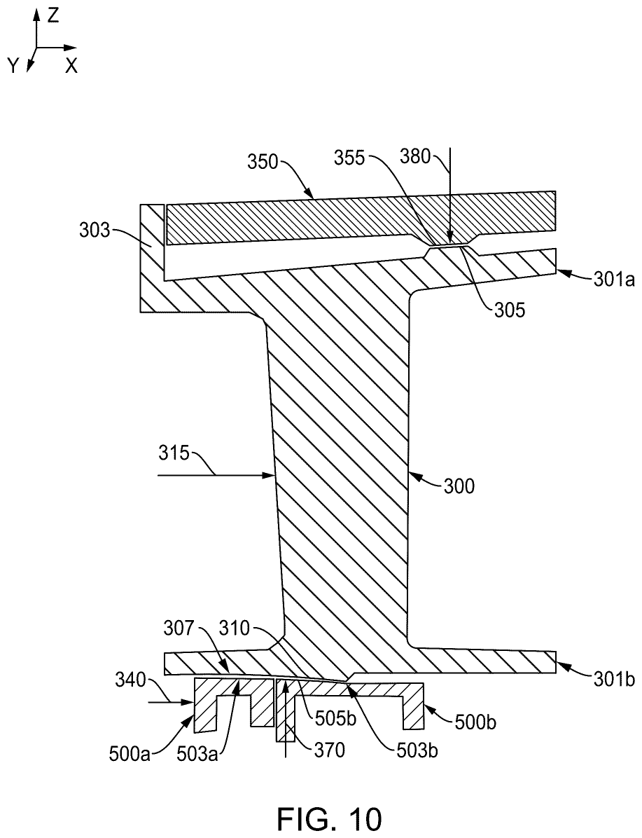

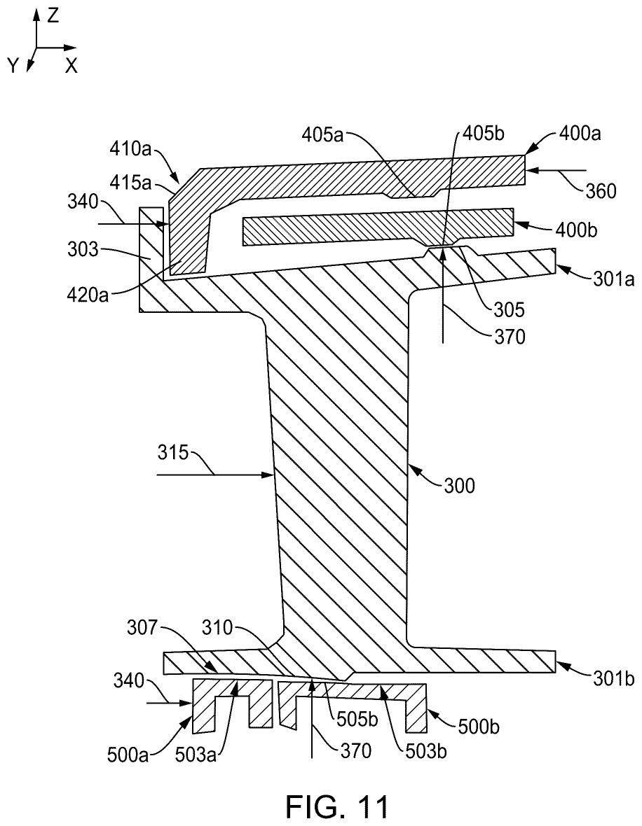

Referring now to FIGS. 10 and 11, in at least one embodiment, two or more inner rings 500a, 500b may replace the single inner ring 320. Inner ring 500a may include an exterior surface 503a whose entire surface area may engage and contact an exterior surface 307 of the inner platform 301b. Inner ring 500b may include an exterior surface 503b having an angled contact surface portion 505b. In at least one embodiment, the entire angled contact surface portion 505b may engage and contact the opposing angled contact surface portion 310 of the platform 301b. During operation, as vane 300 experiences various loads, exterior surface 503a may contact exterior surface 307 as the vane 300 experiences, e.g., radial load, and moves in the aft direction. In contrast, angled contact surface portion 505b may contact the opposing angled contact surface portion 310 as the vane 300 experiences, e.g., aerodynamic load, and moves in the fore direction. As discussed above, a larger cross-sectional area provides a lower stress load (see FIG. 3). Depending on the anticipated load(s), the inner ring 500a may be fabricated having a cross-sectional area suitable to react, reduce and distribute the stress load. For this same reason, the combined cross-sectional area of the opposing contact surface 305 and outer ring 350 also may be fabricated to do the same. In yet another embodiment, the structural configurations of the embodiments of either FIG. 7 or 9 may be combined with the structural configuration of FIG. 10 (see FIG. 11). The motion(s) induced by the aforementioned pressure loads may be stopped by the contact made by the contact surface 405b and opposing contact surface 305, and the angled contact surface portion 505b and the opposing angled contact surface portion 310. These opposing points of contact, that is, opposing contact surface 305 and opposing angled contact surface 310, and the pressure loads experienced at each, may be the cross-corner load experienced by the vane(s) 300.

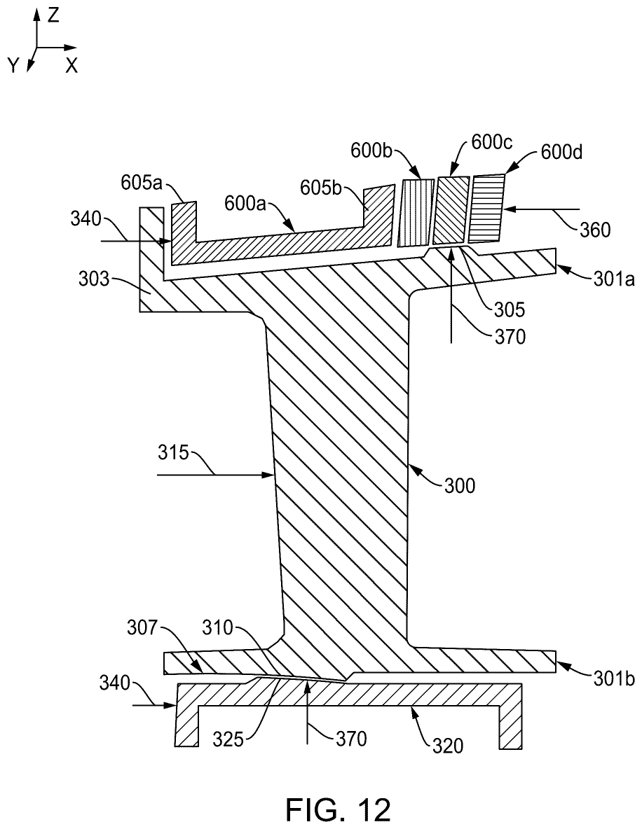

Referring now to FIG. 12, in yet another embodiment, two or more outer rings 600a, 600b, 600c, 600d may replace the single outer ring 350. Outer ring 600a may include a first outer ring flange 605a and a second outer ring flange 605b. In at least one embodiment, during operation, radial force(s) acting in the direction of arrow 370 may cause outer platform 301a to contact outer ring 600a. However, the contact made by opposing contact surface 305 with at least one of outer rings 600b, 600c, 600d may react, reduce and distribute the radial force(s) such that the outer platform 301a does not contact the outer ring 600a. In addition, the axial force(s) acting in the direction of arrows 340, 360 may initiate the outer platform flange 303 contacting the first outer ring flange 605a of the outer ring 600a, which in turn, then contacts outer rings 600b, 600c, 600d and vice versa. In doing so, in either direction of arrows 340, 360, the outer rings 600a, 600b, 600c, 600d may react, reduce and distribute the axial force(s) so that the force(s) are not distributed to the outer turbine casing (not shown). The motion(s) induced by the aforementioned pressure loads may be stopped by the contact made by the outer ring 600c and opposing contact surface 305, and the angled contact surface portion 325 and the opposing angled contact surface portion 310. These opposing points of contact, that is, opposing contact surface 305 and opposing angled contact surface 310, and the pressure loads experienced at each, may be the cross-corner load experienced by the vane(s) 300. Lastly, the air gaps between the outer rings 600a, 600b, 600c, 600d and vane(s) 300 may insulate and facilitate transferring heat from the heat source to the heat sink.

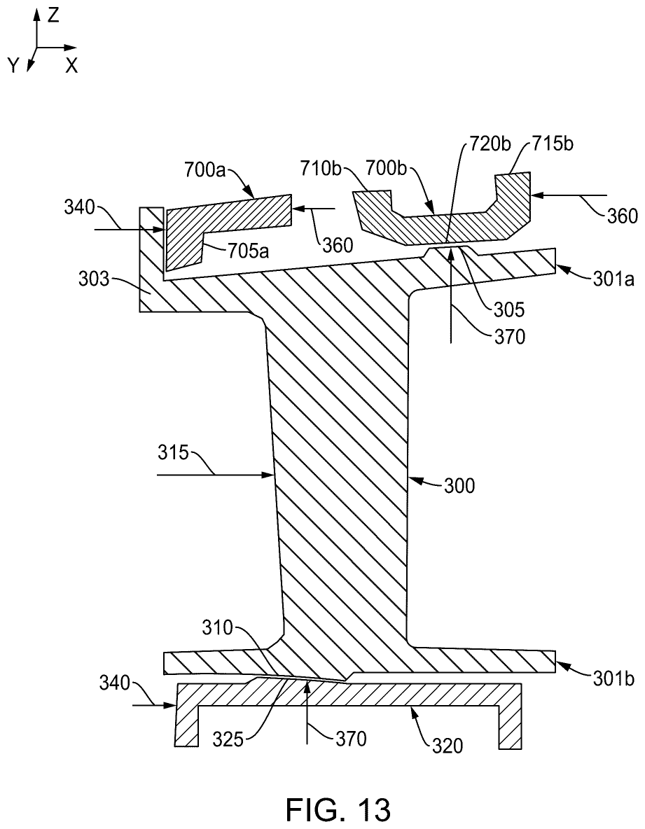

Referring now to FIG. 13, in at least one embodiment, two or more outer rings 700a, 700b may replace the single outer ring 350. The outer ring 700a may be disposed in contact with the outer platform flange 303 via an outer ring flange 705a extending radially-inwardly. The outer ring 700b may include a first outer ring flange 710b and a second outer ring flange 715b; both flanges 710b, 715b may extend radially-outwardly toward the outer turbine casing (not shown). In addition, the outer ring 700b may further include an exterior contact surface 720b that may or may not abut the opposing contact surface 305 of the outer platform 301a. In at least one embodiment, during operation, the outer ring flange 705a may serve as a retainer and engage the outer platform flange 303. That is, the outer ring flange 705a may limit axially forward movement of the vane 300. The outer platform flange 303 and outer ring flange 705a may enable the mechanical support of vane 300 without the need for internal spars to support the load. As discussed above, a larger cross-sectional area provides a lower stress load (see FIG. 3). Depending on the anticipated load(s), the outer ring 700a and contact surface 705a, as well as the outer ring 700b and contact surface 720b, may be fabricated having respective cross-sectional areas suitable to react, reduce and distribute the stress load(s) being experienced. Given the aforementioned structural configuration, the outer rings 700a, 700b may also serve to react out various aerodynamic loads from the vane 300 to an outer turbine case (not shown) as illustrated by arrows 340, 360, 370. The motion(s) induced by the aforementioned pressure loads may be stopped by the contact made by the outer ring 700b and opposing contact surface 305, and the angled contact surface portion 325 and the opposing angled contact surface portion 310. These opposing points of contact, that is, opposing contact surface 305 and opposing angled contact surface 310, and the pressure loads experienced at each, may be the cross-corner load experienced by the vane(s) 300. Lastly, by being separated via insulating air gaps, the outer rings 700a, 700b may not share thermal load through contact.

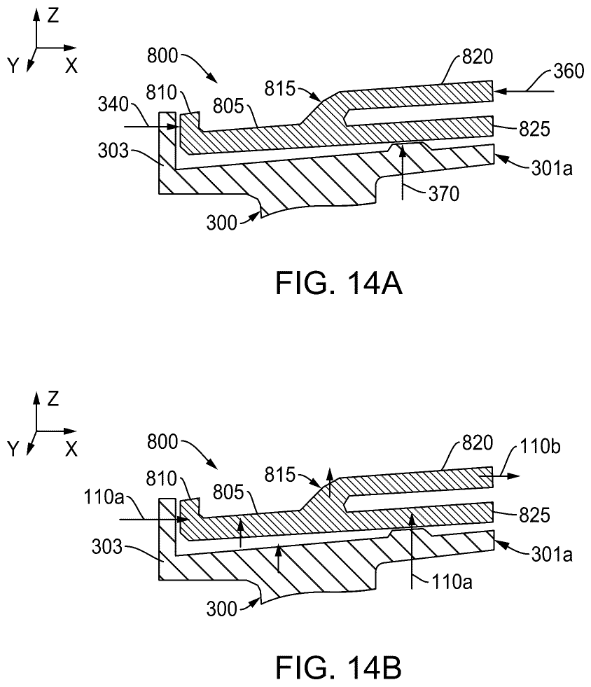

Referring now to FIGS. 14A and 14B, in yet at least one other embodiment, a split ring 800 may replace the two or more rings illustrated in the prior embodiments. The split ring 800 may have a body 805, a radially-outwardly extending flange 810 and an axially-outwardly extending fork 815, opposite the flange 810, having an upper fork portion 820 and a lower fork portion 825. The upper fork and lower fork portions 820, 825 increase the cross-sectional area available to handle the radial force indicated by arrow 370, which decreases the hoop stress experienced by the split ring 800. The split ring 800 may also serve to react out various aerodynamic loads from the vane 300 to an outer turbine case (not shown) as illustrated by arrows 340, 360, 370 (see FIG. 14A). In addition, upper fork and lower fork portions 820, 825 may also increase the distance between the heat source (as indicated by arrows 110a), e.g., vane 300, and the heat sink (as indicated by arrow 110b), which decreases the thermal gradient and thermal stress experienced by the split ring 800 (see FIG. 14B). In addition, upper fork and lower fork portions 820, 825 may also increase the distance between the heat source, e.g., vane 300, and the heat sink, which decreases the thermal gradient and thermal stress experienced by the split ring 800.

The exemplary structural configurations disclosed herein effectively redistribute the high stress(es) caused by high thermal and mechanical loads by splitting the forces and thermal loads between the multiple rings. The exemplary configurations also overcome the manufacturing limitations discussed, which preclude other approaches to address the aforementioned stresses. The multiple rings carry the hoop stress and the axial compression loads compared to the single ring of the prior art. The multiple ring configurations create a thermal gradient, as well as form insulating air gaps, that facilitate transferring heat to the heat sink.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A gas turbine engine, comprising:
a turbine section disposed about an engine axis, the turbine section including a ring comprising an inner ring and an outer ring that define a gas path therebetween, at least one of the inner ring or the outer ring include two or more rings;
at least one vane disposed in the gas path and supported by the inner ring and the outer ring, the at least one vane includes an inner platform, an outer platform, and an airfoil section disposed therebetween,
wherein a first inner ring of the two or more inner rings or a first outer ring of the two or more outer rings include a fore end designed to axially abut an opposing flange defined by the outer platform, and either a contact surface designed to radially abut an opposing contact surface defined by the outer platform, or an angled contact surface designed to abut an opposing angled contact surface defined by the inner platform or both the contact surface designed to radially abut the opposing contact surface defined by the outer platform and the angled contact surface designed to abut the opposing angled contact surface defined by the inner platform.

2. The gas turbine engine of claim 1, wherein the at least one contact surface protrudes radially-outwardly.

3. The gas turbine engine of claim 1, wherein the inner ring includes one ring and the outer ring includes two or more rings.

4. The gas turbine engine of claim 1, wherein the inner ring includes two or more rings and the outer ring includes one ring.

5. The gas turbine engine of claim 1, wherein the inner ring includes two or more rings and the outer ring includes two or more rings.

6. The gas turbine engine of claim 1, wherein the two or more outer rings comprise the first outer ring and a second outer ring, the first outer ring includes a first contact surface, the second outer ring includes a second opposing contact surface, and the first contact surface and the second opposing contact surface are designed to radially abut each other.

7. The gas turbine engine of claim 1, wherein the two or more outer rings define at least one insulating air gap.

8. The gas turbine engine of claim 1, wherein the two or more inner rings define at least one insulating air gap.

9. The gas turbine engine of claim 1, wherein at least one of the two or more outer rings include one or more cooling apertures.

10. The gas turbine engine of claim 1, further comprising at least one insulating air gap defined by one or more of the following: the inner ring, the outer ring and the at least one vane.

11. The gas turbine engine of claim 1, further comprising a compressor section, a combustor in fluid communication with the compressor section and the turbine section.

12. The gas turbine engine of claim 1, wherein at least one of the inner ring, the outer ring and the at least one vane comprises a ceramic-containing material.

13. The gas turbine engine of claim 12, wherein the ceramic-containing material comprises at least one of the following: a silicon-containing ceramic, a ceramic-matrix composite, and combinations thereof.

14. A gas turbine engine, comprising:
a turbine section disposed about an engine axis, the turbine section including a ring comprising an inner ring and an outer ring that define a gas path therebetween, at least one of the inner ring and the outer ring include a split ring;
at least one vane disposed in the gas path and supported by the inner ring and the outer ring, the vane includes an inner platform, an outer platform, and an airfoil section disposed therebetween,
wherein the split ring includes one or more of: (i) at least one aft end or fore end designed to abut an opposing flange defined by at least one of the inner platform and the outer platform, (ii) at least one contact surface designed to abut an opposing contact surface defined by at least one of the inner platform and the outer platform, and (iii) at least one angled contact surface designed to abut an opposing angled contact surface defined by at least one of the inner platform and the outer platform.

15. The gas turbine engine of claim 14, wherein the split ring includes a body having an aft end and a fore end and a fork having an upper fork portion and a lower fork portion, the upper and lower fork portions extending axially-outwardly, the fork being disposed opposite either the aft end or the fore end of the body.

16. The gas turbine engine of claim 14, wherein at least one of the inner ring, the outer ring and the vane comprises a ceramic-containing material.

17. The gas turbine engine of claim 16, wherein the ceramic-containing material comprises at least one of the following: a silicon-containing ceramic, a ceramic-matrix composite, and combinations thereof.
